(19) United States
(12) Patent Application Publication
(10) Pub. No.: US 2012/0242181 A1
(43) Pub. Date: Sep. 27, 2012

(54) ELECTRIC MACHINE EXCITED BY PERMANENT MAGNETS

(75) Inventors: Andreas Gruendl, Starnberg (DE); Bernhard Hoffmann, Starnberg (DE)

(73) Assignee: COMPACT DYNAMICS GmbH, STARNBERG (DE)

(21) Appl. No.: 13/512,834

(22) PCT Filed: Dec. 6, 2010
(86) PCT No.: PCT/EP2010/007401

§ 371 Date: May 30, 2012

(30) Foreign Application Priority Data
Dec. 4, 2009 (DE) 10 2009 057 067.5

(51) Int. Cl. H02K 21/02

(52) U.S. Cl. 310/152

(57) ABSTRACT

In order to provide a compact and highly efficient electric machine having high power density, an electric machine excited by permanent magnets, comprising a stator and a rotor, is provided. The stator comprises a coil arrangement and the rotor has permanent magnet elements. The coil arrangement comprises a winding and surrounds a flux yoke. The flux yoke comprises at least one limb. Between every two limbs, flux guide parts are arranged that are spaced apart from each other and that are aligned with the ends of the limbs. Neighbouring permanent magnet elements have opposing magnetic orientations and are combined to form a magnet disc. On the side facing away from the limbs of the permanent magnet elements, flux guide parts are arranged. The limbs and the flux guide parts face the permanent magnet elements forming an air gap.

### TECHNICAL FIELD

Presented here is an electric machine excited by permanent magnets. This machine has a stator and a rotor, the stator comprising a stator coil and the rotor being provided with permanent-magnet elements, or the rotor comprising a rotor coil and the stator being provided with permanent-magnet elements.

Known from EP 0 218 522 A1 is a synchronously excited electric machine having C-shaped magnetic flux yokes and having magnetic-flux guide pieces, which are disposed in axial rows and which are at least partially in alignment with permanent magnets of the rotor.

### DEFINITION OF TERMS

The term “electric machines excited by permanent magnets” means both motors and generators. It is immaterial in this case whether such a machine is designed as a rotary machine or, for example, as a linear motor. In addition, the invention can be applied both in the case of internal-rotor machines and in the case of external-rotor machines.

### PRIOR ART

Usually, in the prior art, an iron yoke having two limbs is surrounded by a coil. In the case of an electric motor, the current flowing in the coil causes a magnetic flux in the two limbs. This magnetic flux flows from one limb, via an air gap, interacts with the permanent-magnet elements of the rotor and flows, via the air gap, in the other lib. Such electric machines have a limited power density.

An electric machine excited by permanent magnets and having a stator and a rotor is known from DE 197 04 769 A1. In this case, the stator has a coil arrangement and the rotor is provided with a plurality of permanent-magnet elements. The coil arrangement has a winding, which surrounds a flux yoke having two limbs. Disposed between the limbs are first flux guide pieces, which are spaced apart from each other and which are in alignment with the ends of the limbs. Permanent-magnet elements that are adjacent to each other have opposing magnetic orientations in each case, and the permanent-magnet elements are combined to form a magnet disc. Second flux guide pieces are disposed on the side of the permanent-magnet elements that faces away from the ends of the limbs and from the first flux guide pieces. The ends of the limbs and the first and the second flux guide pieces are face towards the permanent-magnet elements, forming an air gap in each case. In certain positions of the rotor relative to the stator, the permanent-magnet elements are at least partially in alignment with at least some of the first or the second flux guide pieces and with the ends of the limbs.

### OBJECT TO BE ACHIEVED

The presented machine and its variants are intended as a way of providing a highly efficient motor or generator having a compact structure and high power density.

### ACHIEVEMENT OF THE OBJECT

To achieve this object, there is proposed an electric machine excited by permanent magnets and comprising a stator and a rotor. In this case, the stator has a coil arrangement and the rotor is provided with a plurality of permanent-magnet elements. As an alternative to this, it is also possible for the rotor to have a coil arrangement and for the stator to be provided with permanent-magnet elements. The coil arrangement has at least one winding and at least partially surrounds a flux yoke. The flux yoke has at least one limb. Disposed between two limbs in each case there are flux guide pieces, which are spaced apart from each other and which are in alignment with the ends of the limbs. Permanent-magnet elements that are adjacent to each other have opposing magnetic orientations, and are combined to form a magnet disc. Flux guide pieces are also disposed on the side of the permanent-magnet elements that faces away from the limbs. The limbs and the flux guide pieces face towards the permanent-magnet elements, forming an air gap. In certain positions of the rotor relative to the stator, the permanent-magnet elements are at least partially in alignment with some of the flux guide pieces.

The effect of this arrangement is that magnetic flux flows from one limb of the flux yoke, alternately through the flow guide pieces and through permanent-magnet elements aligned to the latter, to the other limb of the flux yoke. In the case of one design, the magnetic flux, starting from one of the flux yokes, goes via an air gap into the magnet disc. From the magnet disc, the magnetic flux branches parallelwise, via a respective air gap, into the first and second flux guide pieces disposed on both sides of the magnet disc. The magnetic flux then recombines in the magnet disc, via a respective air gap. This branching and recombining transition of the magnetic flux from the magnet disc to the first and second flux guide pieces is repeated as far as the other limb of the flux yoke. In the case of this design, respectively adjacent permanent-magnet elements are oriented substantially longitudinally in relation to the surface of the magnet disc that faces towards the air gaps.

In the case of another design, the magnetic flux, starting from one of the limbs of the flux yoke, goes via an air gap into the magnet disc. From the magnet disc, the magnetic flux goes via an air gap into a second flux guide piece disposed on the other side of the magnet disc. The magnetic flux then goes via an air gap back into the magnet disc, and from there goes via an air gap into a first flux guide piece disposed on the side of the flux yokes. This to and fro transition of the magnetic flux from the magnet disc to the first and second flux guide pieces is repeated as far as the other limb of the flux yoke. In the case of this design, respectively adjacent permanent-magnet elements are oriented substantially transversely in relation to the surface of the magnet disc that faces towards the air gaps.

In the case of all embodiments, at least two or more first and second flux guide pieces are in each case disposed between two ends of differing limbs, which ends are spaced apart from each other. In this case, the first flux guide pieces are disposed on one side of the magnet disc, and the second flux guide pieces are disposed on the other side of the magnet disc. What is essential in this case is that the flux guide pieces (at least in the direction of the magnetic flux) do not have a magnetically conductive connection, either between each other or to the limbs. In effect, therefore, the magnetic flux can only flow from one of the limbs to the other of the limbs via a plurality of air gaps on both sides of the magnet disc. These air gaps are located between (i) the ends of the limbs and the magnet disc, (ii) the first flux guide pieces and the magnet disc, and (ii) the second flux guide pieces and the magnet disc.

In the case of conventional machines, the magnetic flux normally goes from one of the limbs of the flux yoke, via an air gap, to the permanent-magnet element and then, via the air gap, to the second limb of the flux yoke. In the case of the embodiments presented here, on the other hand, the magnetic flux between two limbs of the flux yokes changes multiply from the permanent-magnet elements of the magnet disc, via the air gap, to the to the first and second flux guide pieces and back again. Consequently, a coil arrangement delivers/receives, between the two limbs, the magnetic flux that has flowed through more than two air gaps/permanent-magnet elements/flux guide pieces.

This provides a comparatively large space for the coil arrangement. In the case of the arrangements presented, this serial passage through a plurality of air gaps results in a very efficient utilization of the space available in the electric machine. The relatively large distance between the two limbs also provides for a high electromotive force through the flux yokes. The serially occurring flux changes at the air gaps, acting in combination with the current flowing through the coil arrangement, are instrumental in generating force (in the case of motor operation). Owing to the improved space utilization, the efficiency, or power density, of the machine is also increased.

### FURTHER DESIGNS AND DEVELOPMENTS OF THE INVENTION

Preferably, the stator comprises the flux yokes and the coil arrangement comprising the flux guide pieces, and the rotor is provided with the permanent-magnet elements. This avoids the need for moving (for example, rotating or longitudinally sliding) current transfers to a coil arrangement provided in the rotor.

The first and the second flux guide pieces, and the magnetic flux yoke and its limbs, are composed of stacked plates containing soft iron, the plates being oriented substantially parallel to an end face of the magnet disc. This end face of the magnet disc is the side face of the magnet disc that faces towards the flux guide pieces and the magnetic flux yokes. The thickness of these plates depends primarily on the frequency of the current flowing through the coil arrangement, since the eddy-current losses increase in as the frequency increases.

In the case of known axial flux machines, sintered shaped parts containing powdered iron are normally used to guide the magnetic flux, with tolerable magnetic losses. In contrast to this, the embodiment presented allows the magnetic flux to be guided in stacks of plates, containing soft iron, that can be produced and mounted in a simple manner. Unexpectedly, the thrust density of the electric machine that can be achieved with the embodiments presented is increased, for a comparable structural space, by approximately twofold to fourfold in comparison with conventional axial or transversal flux machines, without the increase in the ohmic winding losses otherwise associated therewith. Finally, this effect can be achieved through a “series connection” of the permanent-magnet element and stator pole pairings and their assignment to a single coil arrangement having a winding cross section that can be made comparatively large. One coil arrangement is coupled to a plurality of permanent-magnet element and stator pole pairings permeated by the same magnetic flux, and therefore produces the multiple force per coil arrangement.

In a variant of the magnet disc, flux guides containing soft iron are disposed between adjacent, longitudinally oriented permanent-magnet elements.

The coil arrangement surrounds a flux yoke having two limbs that are spaced apart. In this case, the spacing of the limbs in relation to each other, in the region of their ends that face towards the magnet disc, is (i) between 60% and 140%, (ii) preferably between 80% and 120%, and (iii) in particular between 90% and 110% of their length. The magnetic leakage flux components are mostly tolerable if the (magnetically effective) length of the limbs corresponds approximately to their spacing in the region of their ends that face towards the magnet disc.

In the case of a variant, the first and the second flux guide pieces are disposed in an offset manner in relation to each other on both sides of the magnet disc, along the direction of motion. In another variant, the first and the second flux guide pieces are disposed substantially in alignment with each other on both sides of the magnet disc, along the direction of motion.

The magnetic flux guide pieces can have a substantially square shape. It is also possible for them to be given a shape that tapers in width and/or height towards their ends. Such a configuration reduces or minimizes the magnetic leakages fluxes between adjacent magnetic flux guide pieces. In the variants presented, the first and/or the second flux guide pieces have a substantially trapezoidal shape in cross section, the respectively larger base surfaces facing towards the magnet disc.

Furthermore, the first and the second flux guide pieces have a shape, along the direction of motion, in the region of their base surface that faces towards the magnet disc, which is dimensioned such that in each case it is opposite more than one, but not more than two adjacent permanent-magnet elements of the magnet disc.

The coil arrangement can either be operated with a single-phase current or be designed as a multi-phase arrangement (preferably two or more than two). For the latter case, the coil arrangement can have a plurality of windings, disposed next to each other or over each other, which are set up to be operated with an offset in phase in relation to each other. As an alternative to this, it is also possible for a plurality of sectors of coil groups and flux guide pieces to be disposed along the circumference, the individual coil arrangements being operated with currents that differ in phase position. Accordingly, the flux guide pieces are also to be disposed with an offset in the circumferential direction.

In order to increase the stability of the arrangement as a whole, connectors that are magnetically substantially inactive and that fix the relative position of the flux guide pieces in relation to each other can be disposed between adjacent flux guide pieces. These connectors can be composed of diamagnetic material, for example metal, polymerized plastic, or the like. If the connectors are made of metal, they can also consist of one or more of the multiplicity of plates that constitute the flux guide pieces.

The permanent-magnet elements preferably have a substantially square shape. However, they can also have a cross section that is trapezoidal or triangular, or rhomboidal, or the like. In order to increase the mechanical stability of the magnet disc, the magnet disc can be designed as an annular disc, having on its outer circumference and/or its inner circumference a support ring that is magnetically substantially inactive. This applies, in particular, if the magnet disc is part of the rotor.

In a further variant, a coil arrangement, having at least one winding, can be is disposed in each case on both end faces of the magnet disc that face towards the air gaps, which winding at least partially surrounds a flux yoke having at least one limb. It is thereby possible to achieve a very compact design of two winding systems, on both sides of the rotor, in order to increase the torque.

Furthermore, it is possible for each of the limbs to have two ends, first and second flux guide pieces being in each case disposed between the two mutually opposite ends of the limbs.

### BRIEF DESCRIPTION OF THE DRAWING

For persons skilled in the art, further features, properties, advantages and possible modifications are made clear by the following description, in which reference is made to the appended drawing. In the latter, parts that are the same or have the same function are denoted by corresponding references in the figures, and are also represented in similar manner.

FIG. 1 shows a schematic cross section of an embodiment of an electric machine excited by permanent magnets.

FIG. 2 shows an enlarged, lateral, schematic partial view of an electric machine excited by permanent magnets.

FIG. 3 shows an enlarged, lateral, schematic partial view of a further variant electric machine excited by permanent magnets.

FIG. 4 shows a variant of the electric machine excited by permanent magnets, from FIG. 2.

FIG. 5 shows a variant of the electric machine excited by permanent magnets, from FIG. 3.

FIG. 6 shows a variant of a magnet disc having a support ring.

### DETAILED DESCRIPTION OF CURRENTLY PREFERRED EMBODIMENTS

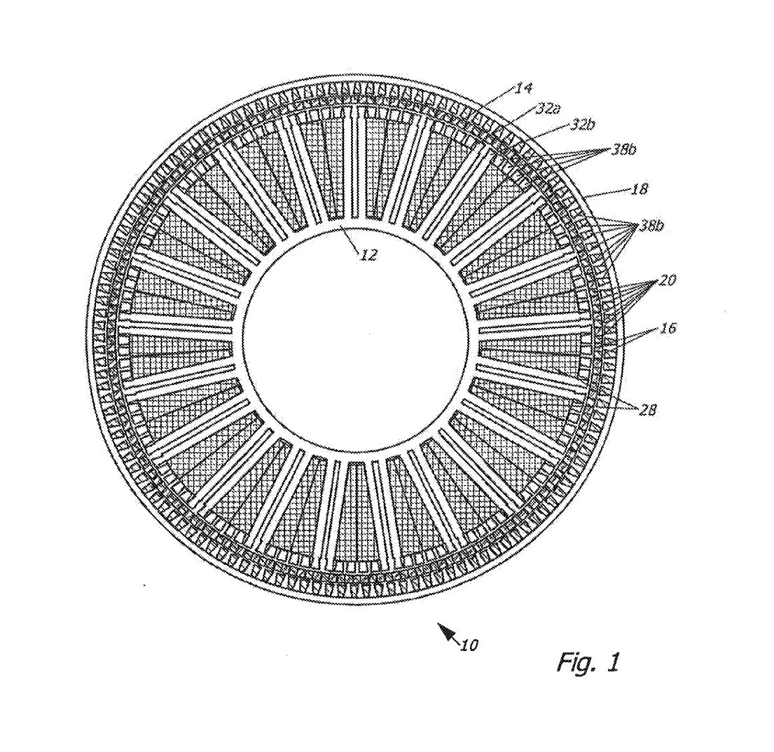

FIG. 1 shows a cross section through an embodiment of an electric machine 10 excited by permanent magnets, which is designed as an external-rotor machine. The principle on which this machine is based can also be used for an internal-rotor machine. The transversal flux machine 10 has a stator 12 and a rotor 14. An air gap 16 is formed between the rotor 14 and the stator 12. The stator 12 is accommodated in a tubular housing 18, which, at each of its two outside ends, has a bearing, not shown, for receiving a drive/output shaft, not shown. The drive/output shaft is connected to the rotor 14 in a rotationally fixed manner, not shown.

In this variant, the stator 12 has a coil arrangement 28. The rotor is provided with a plurality of permanent-magnet elements 20. Permanent-magnet elements 20 that are adjacent to each other have opposing magnetic orientations in each case. The permanent-magnet elements 20 are combined to form a magnet disc 22. In the case of a linearly moving machine, the magnet disc 22 can be a substantially rectangular, sheet-type body. In the case of a rotary machine, the magnet disc 22 can have an annular shape. In this case, depending on the thickness of the permanent-magnet elements 20, the magnet disc 22 can also take on a shape reminiscent of a short tube portion. The permanent-magnet elements 20 can be constituted as cast or cut parts made of an AlNi or AlNiCo alloy, of barium ferrite or strontium ferrite, of an SmCo or NdFeB alloy, or of other rare earth materials. It is thus possible to achieve permanent-magnet energy products (BH)ₘₐₓ in the range from approximately 30 to approximately 300 kilojoules/cubic metre—even in the higher temperature range, from approximately 150 to approximately 180 degrees Celsius.

In order to improve the mechanical stability, the permanent-magnet elements 20 can also be constituted as powder particles embedded in thermostable plastic binders containing, for example, polyamide, polyphene sulfide, thermosetting plastic, epoxy resin, or the like. The thermostable plastic binder can also be methacrylate adhesive, epoxy resin bonding agent, polyurethane adhesive, phenol resin adhesive, fibre-reinforced epoxy resin, or water-repellent epoxy resin casting resin. A metal hoop or ring, made of aluminium or (non-magnetic) steel, that completely encompasses the magnet disc 22 can also be provided, in order to reinforce the mechanical stability.

The coil arrangement 28 here has a multiplicity of windings of the same type. Each of the windings surrounds limbs 32a, 32b of two adjacent flux yokes. Disposed between the free ends of the limbs 32a, 32b there are a plurality of first flux guide pieces 38a, which are spaced apart from each other and which are in alignment with the ends of the limbs 32a, 32b. Second flux guide pieces 38b are disposed on the side of the permanent-magnet elements 20 that faces away from the ends of the limbs 32a, 32b and from the first flux guide pieces 38a. The ends of the limbs 32a, 32b and the first and the second flux guide pieces 38a, 3ab face towards the permanent-magnet elements 20 of the magnet disc 22, forming an air gap 16a, 16b, 16c, 16d in each case.

In certain positions of the rotor 12 relative to the stator 14, the permanent-magnet elements 20 are in alignment, at least partially, with at least some of the first or the second flux guide pieces 38a, 38b and with the end of the limbs 32a, 32b. Upon a motion of the magnet disc relative to the limbs 32a, 32b of the flux yokes 30, 30′ and the first and second flux guide pieces 38a, 38b, magnetic flux flows from one of the limbs 32a, through the permanent-magnet elements 20 and through the first and second flux guide pieces 38a, 38b disposed on both sides of the magnet disc, to the other limb 32b. Two or more first flux guide pieces 38a and two or more flux guide pieces 38b are disposed between two adjacent limbs 32a, 32b. For the present variants, up to four or five first and up to four or five second flux guide pieces 38a, 38b are possible.

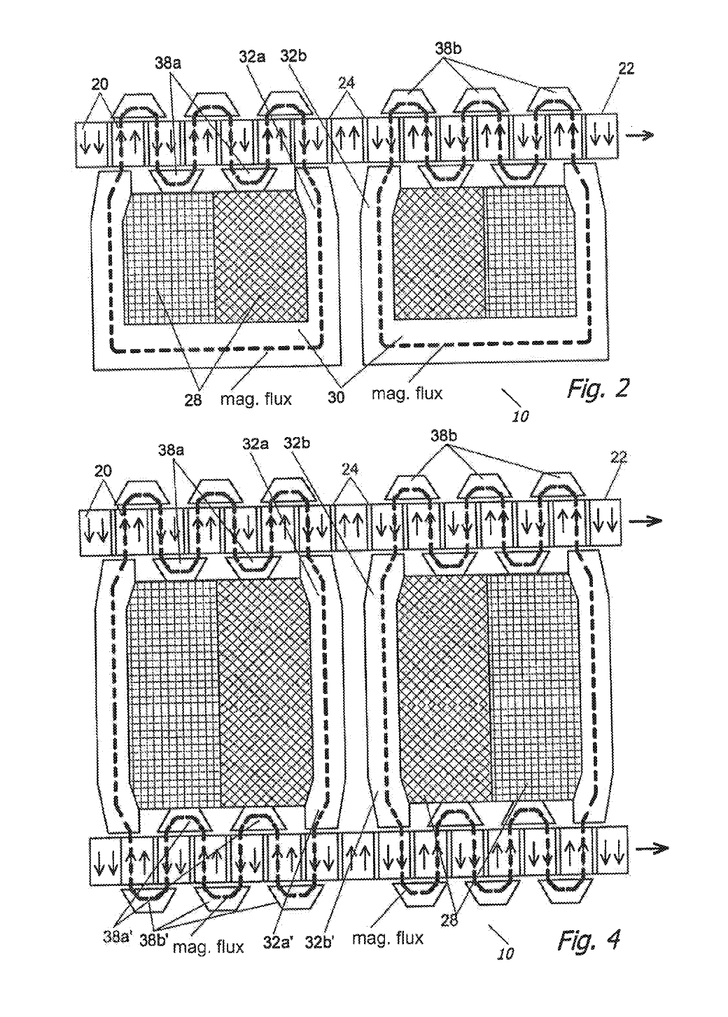

As can be seen clearly from FIGS. 2-5, in particular, respectively two or three first and second flux guide pieces 38a, 38b are disposed between two ends of the limbs 32a, 32b in each case. The magnetic flux, starting from one of the limbs 32a, thus passes through a plurality of air gaps 16a, 16b, 16c, 16d in succession, between (i) the end of the limb 32a and the magnet disc 22, (ii) the first flux guide pieces 38a and the magnet disc 22, and (iii) the second flux guide pieces 38b and the magnet disc 22, to the other limb 32b. The first and the second flux guide pieces 38a, 38b are not connected in a magnetically conductive manner, either between each other or to the limbs 32a, 32b. Depending on the design of the magnet disc and the arrangement of the first flux guide pieces 38a relative to the second flux guide pieces 38b, the magnetic flux can go to and fro through the magnet disc 22, in the manner of a meander, from the end of the one limb 32a to the end of the other limb 32b. In this case, permanent-magnet elements 20 that are adjacent to each other are oriented substantially transversely in relation to the surface of the magnet disc that faces towards the air gaps 16a, 16b, 16c, 16d.

In addition, the first flux guide pieces 38a are disposed in an offset manner in relation to the second flux guide pieces 38b, along the direction of motion. This variant is shown, for example, in FIGS. 2 and 4.

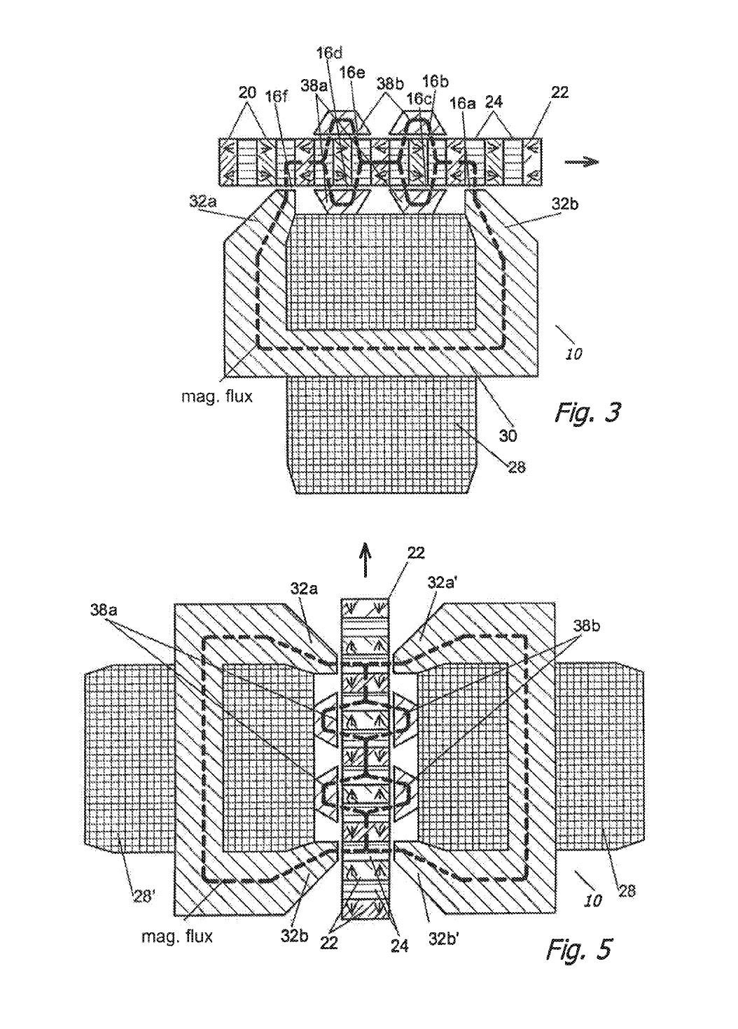

As an alternative to this, permanent-magnet elements 20 that are adjacent to each other can be oriented substantially longitudinally in relation to the surface of the magnet disc that faces towards the air gaps 16a, 16b, 16c, 16d. In this case, the first flux guide pieces 38a can be disposed substantially in alignment in relation to the second flux guide pieces 38b, along the direction of motion of the rotor relative to the stator. Furthermore, in the case of these variants, flux guides 24 containing soft iron are disposed between the adjacent, alternately longitudinally oriented permanent-magnet elements 20 of the magnet disc 22. This variant is shown, for example, in FIGS. 3 and 5.

In FIGS. 2 and 3, in the case of a rotating machine the rotational axis of the rotor can either be disposed vertically in the plane of the drawing or the rotational axis of the rotor runs perpendicularly in relation to the plane of the drawing. The first of these variants is also referred to as a disc rotor; the second of these variants is referred to as a drum-type rotor.

A common design feature realized in the case of all embodiment variants is that the first and the second flux guide pieces 38a, 38b and the limbs of the magnetic flux yoke 30 are constituted by thin, stacked plates containing soft iron. The plates in this case are oriented substantially parallel to an/the end face/faces of the magnet disc 22. Plates that are not thicker than 0.5 mm or 2 mm are referred to as thin plates in this case.

The flux yoke, with its two spaced-apart limbs 32a, 32b, is surrounded by a coil arrangement 28. The spacing of the limbs 32a, 32b in the region of their free ends that face towards the magnet disc is between 60% and 140% of their (magnetically effective) length. In this case, any distance/length ratio lying between these values is deemed as disclosed here. In the variants shown here, the first and the second flux guide pieces 38a, 38b each have a shape that is substantially trapezoidal in cross section. In this case, the respectively larger base surfaces face towards the magnet disc. The first and the second flux guide pieces 38a, 38b in this case are configured, along the direction of motion, in the region of their base surface that faces towards the magnet disc, such that more than one, but not more than two adjacent permanent-magnet elements 20 of the magnet disc are opposite a flux guide piece in each case.

The pole pitch of the permanent-magnet elements 20 corresponds approximately to half (approximately 35% to 65%) of the pole pitch of the first and the second flux guide pieces 38a, 38b.

In order to increase the mechanical stability, connectors 60 that are magnetically substantially inactive and that fix the relative position of the flux guide pieces 38a, 38b in relation to each other can be disposed between adjacent flux guide pieces. A thermostable plastic binder containing, for example, polyamide, polyphene sulfide, thermosetting plastic, epoxy resin, or the like can be used for this purpose. The plastic binder can also be methacrylate adhesive, epoxy resin bonding agent, polyurethane adhesive, phenol resin adhesive, fibre-reinforced epoxy resin, or water-repellent epoxy resin casting resin.

FIG. 4 shows a variant in which each of the limbs 32a, 32b has two ends. In this case, a magnet disc 22, 22′ is in each case disposed at both ends of the limbs. In this design of the machine, first and second flux guide pieces 38a, 38b; 38a′, 38b′ are likewise disposed in each case between mutually opposite ends of the limbs 32a, 32b; 32a′, 32b′. Here, a coil arrangement 28 is provided for both magnet discs 22, 22′.

FIG. 5 shows a variant in which a flux yoke 30, 30′ is in each case disposed on both sides of the end faces of the magnet disc 22 that face towards the air gaps. Each of the flux yokes 30, 30′ has two limbs 32a, 32b; 32a′, 32b′, which are in alignment with each other. The first and second flux guide pieces 38a, 38b disposed on both sides of the magnet disc 22, between the limbs 32a, 32b; 32a′, 32b′, are also disposed in alignment with each other.

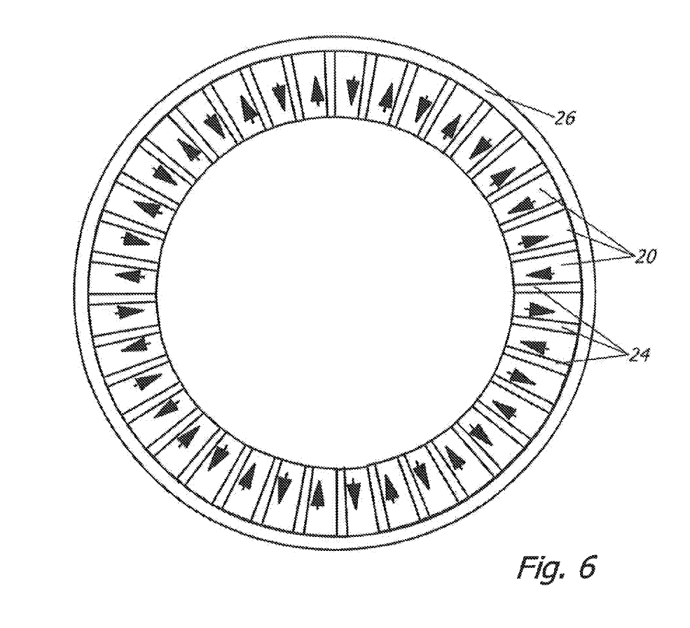

In order to increase the stability, the magnet disc is designed as an annular disc, having on its outer circumference and/or its inner circumference a support ring 26 (see, for example, FIG. 6) that is magnetically substantially inactive.

The ratios of the individual parts and portions thereof in relation to each other, and their dimensions and proportions, that are shown in the figures are not to be understood as limiting. Rather, individual dimensions and proportions can also differ from those shown.

1. Electric machine excited by permanent magnets and comprising a stator and a rotor,
either the stator having a coil arrangement and the rotor being provided with a plurality of permanent-magnet elements, or the rotor having a coil arrangement and the stator being provided with permanent-magnet elements,
the coil arrangement having at least one winding and at least partially surrounding a flux yoke that has at least one limb,
there being disposed between the limbs first flux guide pieces, which are spaced apart from each other and which are in alignment with the ends of the limbs, the first flux guide pieces not having a magnetically conductive connection either between each other or to the limbs,
permanent-magnet elements that are adjacent to each other each having opposing magnetic orientations, and the permanent-magnet elements being combined to form a magnet disc,
second flux guide pieces being disposed on the side of the permanent-magnet elements that faces away from the ends of the limbs and from the first flux guide pieces, the second flux guide pieces not having a magnetically conductive connection either between each other or to the limbs,
the ends of the limbs and the first and the second flux guide pieces facing towards the permanent-magnet elements, forming an air gap in each case, and
in certain positions of the rotor relative to the stator the permanent-magnet elements being at least partially in alignment with at least some of the first or the second flux guide pieces and with the ends of the limbs.

2. Electric machine excited by permanent magnets, according to claim 1,
at least two or more first and second flux guide pieces being in each case disposed between two ends of the limbs in each case, such that the magnetic flux, from one of the limbs, passes through a plurality of air gaps in succession, between
the ends of the limbs and the magnet disc,
the first flux guide pieces and the magnet disc, and
the second flux guide pieces and the magnet disc, and the other limb,
such that, upon a motion of the magnet disc relative to the flux yokes and the first and second flux guide pieces, magnetic flux flows from one of the limbs, through the permanent-magnet elements and through the first and second flux guide pieces disposed on both sides of the magnet disc, to the other limb.

3. Electric machine excited by permanent magnets, according to claim 1,
the first and the second flux guide pieces and the magnetic flux yoke being composed of stacked plates containing soft iron, the plates being oriented substantially parallel to an end face of the magnet disc.

4. Electric machine excited by permanent magnets, according to claim 1,
adjacent permanent-magnet elements being oriented substantially transversely or substantially longitudinally in relation to the surface of the magnet disc that faces towards the air gaps.

5. Electric machine excited by permanent magnets, according to claim 4,
flux guides containing soft iron being disposed between adjacent, longitudinally oriented permanent-magnet elements of the magnet disc.

6. Electric machine excited by permanent magnets, according to claim 1,
at least two first flux guide pieces and at least two second flux guide pieces being disposed between two spaced-apart limbs.

7. Electric machine excited by permanent magnets, according to claim 1,
the first flux guide pieces and the second flux guide pieces being disposed in an offset manner, along the direction of motion, in relation to each other, or being disposed substantially in alignment with each other.

8. Electric machine excited by permanent magnets, according to claim 1,
the first and/or the second flux guide pieces having a substantially trapezoidal shape in cross section, the respectively larger base surfaces of the flux guide pieces facing towards the magnet disc.

9. Electric machine excited by permanent magnets, according to claim 1,
the first and/or the second flux guide pieces having a shape, along the direction of motion, in the region of their base surface that faces towards the magnet disc, which in each case is opposite more than one, but not more than two adjacent permanent-magnet elements of the magnet disc.

10. Electric machine excited by permanent magnets, according to claim 1,
the coil arrangement having a plurality of windings, which are disposed coaxially next to each other and which are set up to be operated with an offset in phase in relation to each other.

11. Electric machine excited by permanent magnets, according to claim 1,
connectors that are magnetically substantially inactive and that fix the relative position of the flux guide pieces in relation to each other being disposed between adjacent flux guide pieces.

12. Electric machine excited by permanent magnets, according to claim 1,
the magnet disc is designed as an annular disc, having on its outer circumference and/or its inner circumference a support ring that is magnetically substantially inactive.

13. Electric machine excited by permanent magnets, according to claim 1,
a coil arrangement, having at least one winding, being disposed in each case on both end faces of the magnet disc that face towards the air gaps, which winding at least partially surrounds a flux yoke having at least one limb.

14. Electric machine excited by permanent magnets, according to claim 1,
each of the limbs having two ends, and first and second flux guide pieces being in each case disposed between the two mutually opposite ends of the limbs.
